(19) United States
(12) Patent Application Publication
(10) Pub. No.: US 2003/0084766 A1
(43) Pub. Date: May 8, 2003

(54) Ductwork sheet metal and insulation cutting arrangement

(75) Inventors: Joseph Massaro, Mahopac, NY (US); John Pulaski, West Town, NY (US); David Derocher, Hopedale, MA (US)

Correspondence Address: Donald N. Halgoen, 35 Central Street, Manchester, MA, 01944, US

(73) Assignee: EastCoast Inc, Hopewell Junction, NY

(21) Appl. No.: 10/003,646

(22) Filed: Nov. 2, 2001

(51) Int. Cl. B26D 7/06

(52) U.S. Cl. 83/23; 83/78; 83/614

(57) ABSTRACT

An apparatus for the proper shaped cutting of alternate components of sheet material fittings for subsequent joining as ductwork. The apparatus comprises a main support platform defined by a rectangular peripheral frame of side beams and end beams and a cutter head movably arranged over the platform to cut sheet material on the platform. A first shuttle table for receipt of a first piece of sheet material is supported on the platform. A second shuttle table for receipt of a second piece of sheet material is also supported alternately, on the platform. A roller bearing set is arranged on the platform to permit one of the shuttle tables to be moved onto the platform as the other of the tables is moved from the platform, to permit alternate pieces of sheet material to be cut by the cutter head over the platform in sequence with one another.

### BACKGROUND OF THE INVENTION

1. Field of the Invention

This invention relates to an apparatus for sequentially cutting sheet metal and insulation, particularly for heating and ventilation systems.

2. Prior Art

In the heating, ventilation and air conditioning industry, ducts for buildings are of necessity, individually designed and cut. Such ductwork to support heating, ventilation and air conditioning systems must be routed according to the peculiarities of the building of which they are to be installed. Such ductwork is typically manufactured from sheet steel and will have a non-metallic insulation liner for either temperature and/or sound control. Such individual sheets of material are typically standard sized five foot by ten foot sheets which loaded by hand onto a cutting table. A cutter might then cut a series of standard sheets of metal for a ductwork arrangement, and then may be utilized to cut a corresponding series of standard sized insulation panels which are to be secured to those cut metal sheets.

This type of operation may often lead to confusion as to the proper pairing of the cut insulation panels and the cut sheet metal panels which adds to the cost, to the time and to the handling operation.

It is an object of the present invention to overcome the disadvantages of the prior art.

It is a further object of the present invention to provide a ductwork cutting arrangement which optimizes efficiency and minimizes the likelihood of error in pairing the sheet metal cut with the insulation layer cut.

It is yet a still further object of the present invention to provide an apparatus which minimizes the space required to perform both the cutting of sheet metal and the cutting of the insulation layer for that sheet metal.

### BRIEF SUMMARY OF THE INVENTION

The present invention comprises a heating ventilation and air conditioning ductwork cutting arrangement for cutting flat pieces of sheet metal and corresponding flat pieces of acoustic/temperature liner to correspond with that cut sheet metal, utilized in the formation of that ductwork.

Such a cutting arrangement comprises a generally rectilinear support platform. The support platform comprises a rectangular frame having a pair of parallel, spaced-apart side beams joined with a pair of parallel space apart first and second end beams. The side beams and end beams are joined at the respective corners to a set of legs which maintains the support platform on a floor.

A rectangular first table and a rectangular second table are joined along a common longitudinal edge. The first table and the second table are movably supported on rollers between the first end beam and the second end beam of the main support platform. The first table and the second table are each of the same area as the area defined by the side beams and end beams of the main support platform.

The first table and the second table are arranged to be moved into the area defined by main support platform when its adjacent second table or first table is shuttled therefrom. The first table and the second table are defined by a plurality of parallel spaced apart support grids longitudinally disposed thereon which are also supported by a plurality of parallel spaced apart transversely arranged support rods.

In one embodiment, a longitudinally disposed drive belt may be arranged over a first side beam of the main support platform. The longitudinal drive belt extends over a first guide rail. The longitudinal drive belt has a portion which is in driving engagement with a computer controlled cutter head supported on a travel beam. The travel beam may, in a further embodiment, be moved by a computer controlled pinion gear engaged with a rack on the first side beam of the main support platform. The computer controlled cutter head carries a cutting mechanism thereon. The cutting mechanism may be comprised of a plasma torch or a water jet cutter or the like.

The computer controlled cutter head is movably disposed on the travel beam. The cutter head preferably has a computer controlled drive motor with a pinion gear thereon. The travel beam has a rack aligned thereon in engagement with the pinion gear so as to permit the computer controlled cutter head to traverse the longitudinal length of the travel beam. The travel beam is also longitudinally displacable itself, along the longitudinal drivebelt or the rack and pinion arrangement disposed upon the rail on the first side beam of the main support platform.

The computer controlled cutting head with the cutting mechanism thereon is arranged by proper computer control, to movably displace the cutter apparatus in a pre-programmed pattern above the main support platform. The cutting arrangement, that is, the torch or jet or blade is arranged to engage a planar piece of sheet metal and/or insert respectively placed on the first table or the second table.

In operation of the present invention, a worker would preload a piece of sheet metal onto for example, the second table, and a sheet of insulation material of generally similar size onto the first table. The machine would be actuated and the cutter head would begin to move by virtue of the signals provided to it from the computer, as to the direction, length and type of cut to be made into the piece of sheet metal lying on the second table, after that second table was positioned under the cutter head. The cutter head would move along the transverse beam and longitudinally along the parallel side beams, as driven by the rack and pinion gear arrangement or alternatively by a longitudinal drive belt and/or the pinion and rack gearing arrangement motivated by the drive motor.

After one or more pieces of standard sheet metal is cut to its proper “fitting” dimensions producing one or more cut sheet metal “fittings” which comprise ductwork, the second table would be shuttled to a second side of the main support platform and the first table would be shuttled into the work area defined by the main support platform after a worker had placed the similarly sized insulative material thereon. A worker may then remove the now cut and properly dimensioned pieces (fittings) of sheet metal from the second table while the computer controlled cutter head is cutting one or more similar patterns corresponding to that pattern of the “just cut” sheet metal “fittings” this time onto the sheet of insulative material lying on the first table. The worker may thus, once the insulative sheet material has been finally cut into proper “fittings”, then put those insulative material “fittings” directly with the sheet metal “fittings” to which it/they is/are to be mated.

Thus no mismatching occurs because of the corresponding cuts or “fittings” are made sequentially by the same cutting mechanism and under the control of computer program controlling cutter head on the traveling beam. It is to be noted that the insulative material “fittings” may be dimensionally smaller than the size of the sheet metal fittings being cut to allow/accommodate for folds and bends in the sheet metal accordingly, particularly when they are attached to the “inward side” of that sheet metal.

Thus there has been shown a unique manufacturing approach to the systematic and efficient production of sheet metal fittings and corresponding insulative layer fittings therefor, such combined members to be utilized in customized heating ventilation and air conditioning ductwork.

The invention thus comprises an apparatus for the proper shaped cutting of alternate components of sheet material for subsequent joining as ductwork, comprising: a main support platform defined by a rectangular peripheral frame of side beams and end beams; a cutter head movably arranged over the platform to cut sheet material on the platform; a first shuttle table for receipt of a first piece of sheet material supported on the platform; a second shuttle table for receipt of a second piece of sheet material supported on the platform; and a roller arrangement on the platform to permit one of the shuttle tables to be moved onto the platform as the other of the tables is moved from the platform, to permit alternate pieces of sheet material to be cut by the cutter head over the platform in sequence with one another. The first table and said second table may be joined by a common bar. The cutter head preferably includes a drive motor and a cutter torch. The cutter head is movably supported in a traveling beam. The traveling beam is movably supported on the side beams of the platform. The traveling beam may be moved by a drive belt or a rack and pinion arrangement supported adjacent a first beam of the side beams. A wheel may be arranged beneath an outer side edge of the tables to support the tables when the tables are extended from the platform in a non-cutting position.

The invention also includes a method for the proper shaped cutting of alternate components or fittings of sheet material for subsequent joining as ductwork, comprising: providing a main support platform defined by a rectangular peripheral frame of side beams and end beams; movably supporting a cutter head over the platform to cut sheet material on the platform; moving a first shuttle table adjacent the platform for receipt of a first piece of sheet material to be supported on the platform; moving a second shuttle table onto the platform for receipt of a second piece of sheet material supported on the platform; and moving the cutter head over the table on the platform to permit a first alternate piece of sheet material to be cut by the cutter head over the platform; and then moving the second table from the platform as the first table is moved onto the platform to permit alternate sheets of material to be cut in sequence with one another. The method may include cutting subsequent alternate pieces of sheet material into plural fittings in correspondence with one another to permit efficient joining of those alternate sheets of material and moving the cutter head by a gearing arrangement driven by a computer controlled motor on the traveling beam. The method may include moving the cutter head by a drive belt arrangement or by a rack and pinion arrangement driven by a computer controlled motor on the traveling beam.

The method may also be characterized as a method for the proper shaped cutting of alternate components of sheet material fittings for subsequent joining of said fittings as multiple fitting component ductwork, comprising: providing a main support platform defined by a rectangular peripheral frame of side beams and end beams; movably supporting a cutter head over the platform to cut sheet material on the platform; placing a first piece of first sheet material on a first shuttle table adjacent the platform for receipt of the first piece of sheet material to be supported on the platform; moving the first shuttle table onto the platform; placing a first piece of a second sheet material onto a second shuttle table adjacent the platform; and controllably moving the cutter head over the first shuttle table on the platform to permit the first piece of first sheet material to be cut by the cutter head over the platform; cutting the first piece of sheet material; and then moving the second shuttle table onto the platform simultaneously as the first shuttle table is moved from the platform to permit the second sheet of material to be cut in sequence after the piece of first material has been cut.

### BRIEF DESCRIPTION OF THE DRAWINGS

The objects and advantages of the present invention will become more apparent when viewed in conjunction with the following drawings in which;

FIG. 1 is a perspective view of the main support platform and cutting tables of the present invention, from a prospective adjacent the first table;

FIG. 2 is a view similar to FIG. 1 from the perspective from the corner of the second table;

FIG. 3 is a view taken along the lines of 3-3 of FIG. 1;

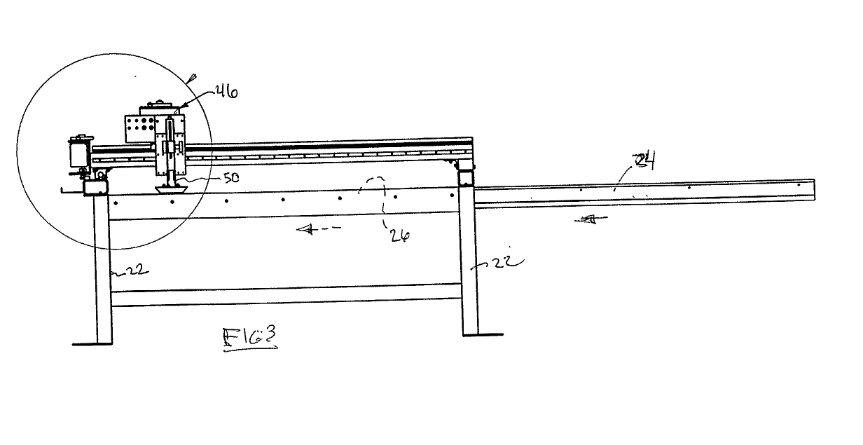

FIG. 4 is a view taken along the lines 4-4 of FIG. 1;

FIG. 5 is a side elevational view of the support table and cutter head; and

FIG. 6 is a side elevational view of the cutter head and traveling beam arranged on a portion of the main support platform.

### DETAILED DESCRIPTION OF THE PREFERRED EMBODIMENTS

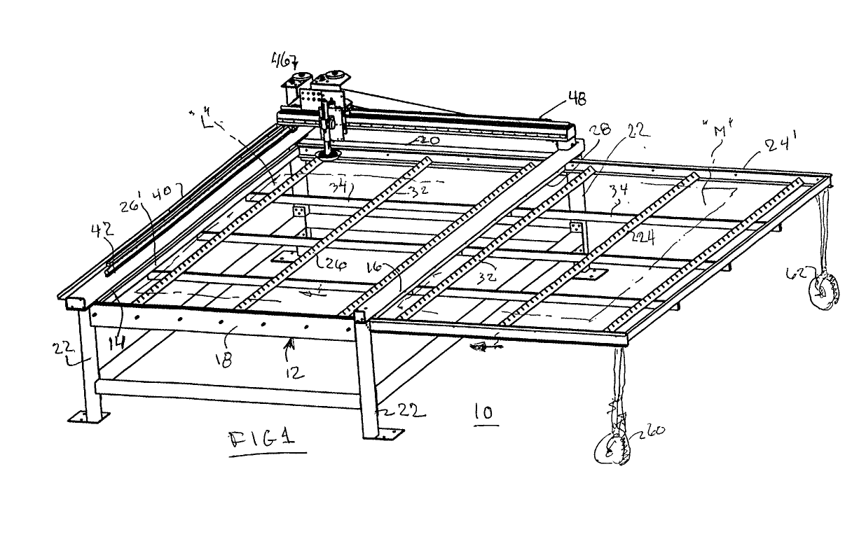

Referring now to the drawings in detail, and particularly to FIG. 1, there is shown the present invention which comprises a heating ventilation and air conditioning ductwork cutting apparatus 10 for cutting flat pieces of standard sized sheet metal “M” into “fittings” and to cut corresponding standard sized pieces of acoustic/temperature liner “L” also into “fittings” to correspond with that cut sheet metal “M” utilized in the formation of that ductwork.

Such a cutting apparatus 10 comprises a generally rectilinear support platform 12. The support platform 12 comprises a rectangular frame having a pair of parallel, spaced-apart side beams 14 and 16 joined with a pair of parallel spaced-apart first and second end beams 18 and 20. The side beams 14 and 16 and the end beams 18 and 20 are joined at the respective corners to a set of legs 22 which maintains the support platform 12 level on a floor.

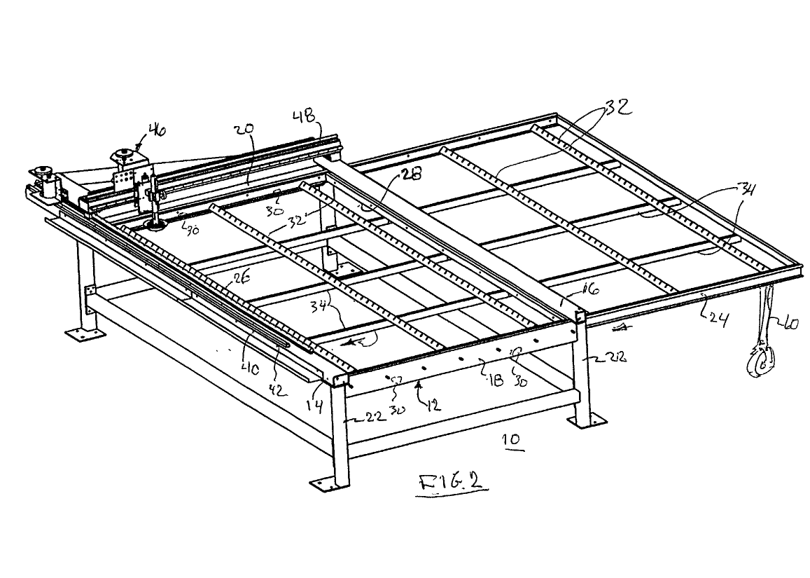

A rectangular first table 24 and a rectangular second table 26 are joined along a common longitudinal bar 28, as may be best seen in FIG. 2. The first table 24 and the second table 26 are movably supported on rollers 30 between the first end beam 18 and between the second end beam 20 of the main support platform 12. The first table 24 and the second table 26 are preferably each of the same area as the area defined by the side beams 14 and 16 and the end beams 18 and 20 of the main support platform 12.

The first table 24 and the second table 26 are arranged to be moved into the rectangular area defined by main support platform 12 when its adjacent second table 26 or first table 24 is shuttled therefrom. The first table 24 and the second table 26 are defined by a plurality of parallel spaced apart support grids 32 longitudinally disposed thereon which are also supported by a plurality of parallel spaced apart transversely arranged support rods 34 surrounded by their respective peripheral frames 26′ and 24′ as shown in FIG. 1.

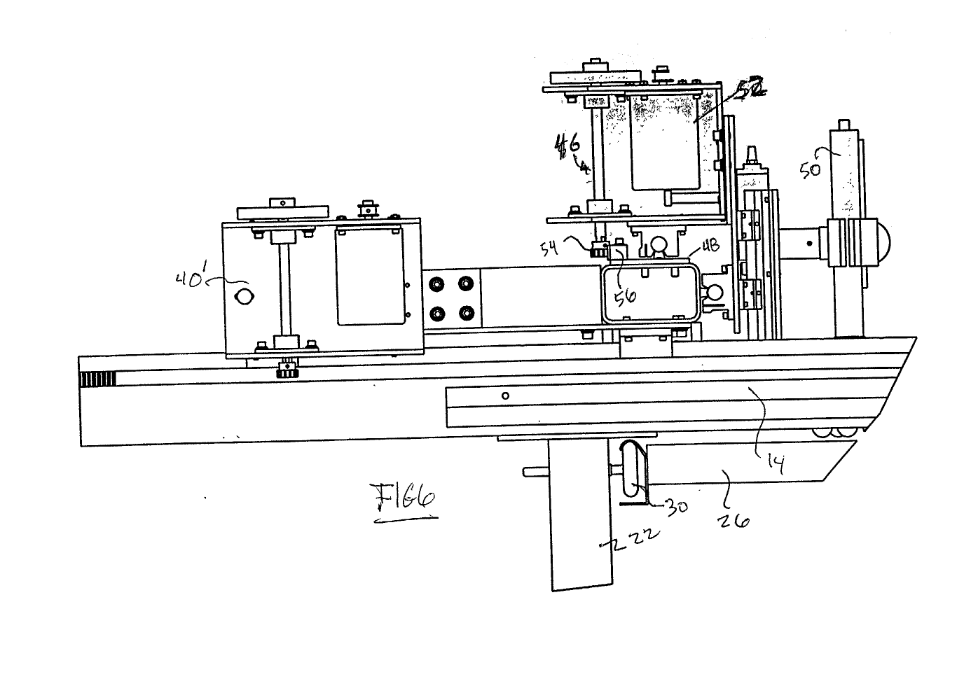

A longitudinally disposed drive belt 40 may in one embodiment, be arranged over the first side beam 14 of the main support platform 12, as indicated in FIGS. 1 and 2. In one embodiment, a longitudinal drive belt 40 extends adjacent a first guide rail 42. The longitudinal drive belt 40 has a portion which is in driving engagement with a computer controlled cutter head 46 supported on a travel beam 48. Alternatively, the drive belt may instead, in a further preferred embodiment be comprised of a rack and pinion arrangement 40′, as shown in FIG. 6, arranged between the travel beam 48 and the first side beam 14 to move the travel beam 48 and its attached cutter head 46 over whichever table 26 or 24 is shuttleably supported within the support platform 12.

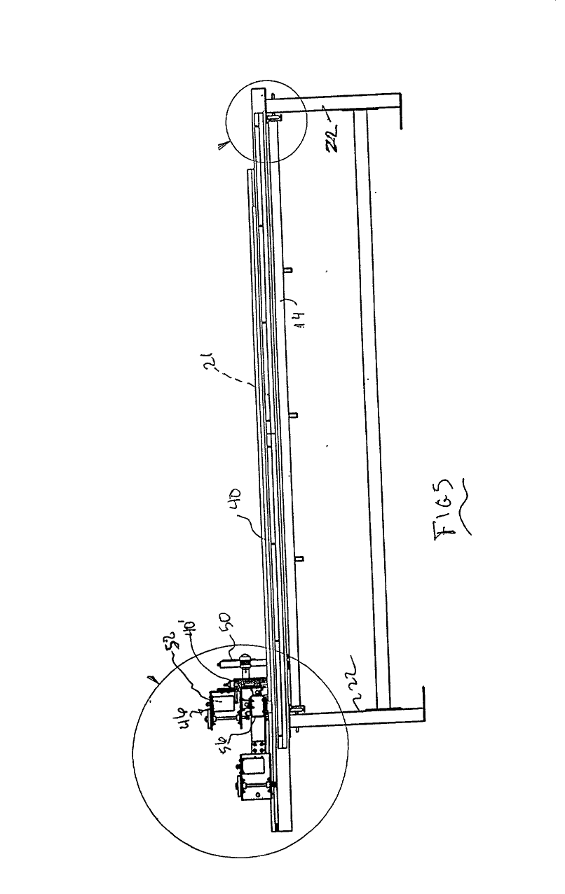

The computer controlled cutter head 46 carries a cutting mechanism 50 thereon. The cutting mechanism 50 may be comprised of for example, a plasma torch, a water jet cutter, a rotary cutter blade or the like. The computer controlled cutter head 46 is movably disposed on the travel beam 48. The cutter head 46 has a computer controlled drive motor 52 preferably with a pinion gear 54 thereon, as best shown in FIGS. 5 and 6. The travel beam 48 has a rack 56 aligned thereon in engagement with the pinion gear 54 so as to permit the computer controlled cutter head 46 to accurately and controllably traverse the longitudinal length of the travel beam 48. The travel beam 48 is also longitudinally displacable itself, by the drive mechanism 40′ such as for example, the rack and pinion gearing arrangement as shown in FIG. 6, or a longitudinal drivebelt arrangement 40 disposed upon the rail on the first side beam 14 of the main support platform 12, as depicted in FIG. 5.

The computer controlled cutting head 46 with the cutting mechanism 50 thereon is arranged by a proper software computer control, to movably displace the cutter apparatus in a pre-programmed pattern above the main support platform 12. The cutting arrangement 46, that is, the torch, cutter blade or water jet is arranged to sequentially engage a planar piece of standard size sheet metal “M” and then for example, an insulative insert “L” respectively shuttled thereunder by virtue of their being placed on the movable first table 24 or the movable second table 26.

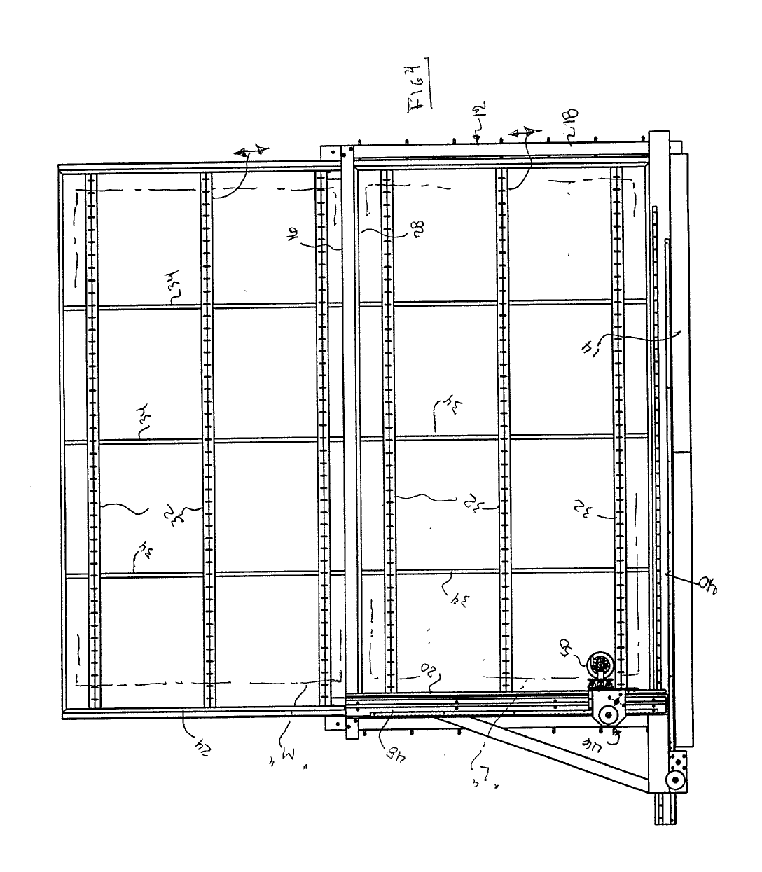

In operation of the present invention, a worker would preload a piece of generally standard sized sheet metal “M” (i.e. 5′×10′) onto for example, the second table 26, and a sheet of insulation material “L” of generally similar size onto the first table 24, as depicted in FIGS. 1 and 4. The apparatus 10 would be actuated and the cutter head 46 would begin to move by virtue of the signals provided to it from the computer, not shown for clarity, as to the direction, length and type of cuts to be made into the piece of sheet metal “M” lying for example, on the second table 26. The cutter head 46 would move transversely along the transverse beam 48 and longitudinally along the parallel side beams 14 and 16 as driven by the pinion gear arrangement or longitudinal drive belt 40 and also the pinion and rack gearing arrangement 54 and 56 motivated by the drive motor 52 on the transverse traveling beam 48 itself.

After the piece of sheet metal “M” is cut to its proper dimensions to generate one or more metal “fittings”, the second table 26 would be shuttled to a second side to extend beyond the main support platform 12 (to the left as may be envisioned in FIG. 1) and the first table 24 would hence be shuttled into the work area defined by the main support platform 12 after a worker had placed the similarly sized insulative material “L” thereon. A worker may then remove the now cut and properly dimensioned piece(s) of sheet metal “M” fittings from the second table 26 while the computer controlled cutter head 46 is cutting a similarly shaped pattern of insulative fittings corresponding to that pattern of the “just cut” sheet metal “M”, now onto the insulative material “L” lying on the first table 24. The worker may thus, once the insulative material “L” has been finally cut, put the insulative material “L” fittings directly with the sheet metal “M” fittings to which it/they is/are to be mated. A pair of wheels 60 and 62 may be arranged beneath each outer edge of each first and second table 24 and 26, only the first table 24 being so shown in FIG. 1, to support those tables 24 and 26 when they are in an “off-platform” position.

Thus no mismatching occurs because of the corresponding cuts of fittings are made sequentially by the same cutting mechanism and under the control of computer program controlling cutter head on the traveling beam. It is to be noted that the insulative material may be slightly dimensionally different (smaller) than the size of the sheet metal being cut to allow for folds and bends in the final forming of the sheet metal accordingly.

Thus there has been shown a unique manufacturing approach to the systematic and efficient production of sheet metal and corresponding insulative layers therefor, such combined members to be utilized in customized heating ventilation and air conditioning ductwork.

We claim:

1. An apparatus for the proper shaped cutting of alternate components of sheet material fittings for subsequent joining as ductwork, comprising:
a main support platform defined by a rectangular peripheral frame of side beams and end beams;
a computer controlled cutter head movably arranged over said platform to cut sheet material on said platform;
a first shuttle table for receipt of a piece of first sheet material to be supported on said platform;
a second shuttle table for receipt of a piece of second sheet material to be supported on said platform; and
a roller arrangement on said platform to permit one of said shuttle tables to be moved onto said platform as the other of said tables is moved from said platform, to permit alternate first and second pieces of metal and insulative sheet material to be alignably cut in a slight size differential by said cutter head over said platform in corresponding sequence with one another.

2. The apparatus as recited in claim 1 wherein said first table and said second table are joined by a common elongated bar arranged therebetween to permit simultaneous movement thereof.

3. The apparatus as recited in claim 1, wherein said cutter head is movably supported on a traveling beam over said platform.

4. The apparatus as recited in claim 3, wherein said cutter head includes a drive motor to permit movement of said cutter head on said traveling beam.

5. The apparatus as recited in claim 4, wherein said traveling beam is movably supported on said side beams of said platform by a drive mechanism arranged therebetween.

6. The apparatus as recited in claim 5, wherein said drive mechanism on said traveling beam comprises a drive belt supported adjacent a first beam of said side beams.

7. The apparatus as recited in claim 5, wherein said drive mechanism on said traveling beam comprises a rack and pinion arrangement supported adjacent a first beam of said side beams.

8. The apparatus as recited in claim 1, wherein a wheel is arranged beneath an outer side edge of said tables to support said tables when said tables are extended to one side of said platform in a non-cutting position.

9. A method for the proper shaped cutting of alternate components of sheet material fittings for subsequent joining of said fittings as a multiple-fitting component ductwork, comprising:
providing a main support platform defined by a rectangular peripheral frame of side beams and end beams;
movably supporting a cutter head over said platform to cut sheet material on said platform;
placing a first piece of first sheet material on a first shuttle table adjacent said platform for receipt of said first piece of sheet material to be supported on said platform;
moving said first shuttle table onto said platform;
placing a first piece of a second sheet material dissimilar from said first sheet of material onto a second shuttle table adjacent said platform; and
controllably moving said cutter head over said first shuttle table on said platform to permit said first piece of first sheet material to be cut by said cutter head over said platform;
cutting said piece of first sheet material; and then
moving said second shuttle table onto said platform simultaneously as said first shuttle table is moved from said platform to permit said sheet of second material to be cut in sequence after said piece of first material has been cut.

10. The method as recited in claim 9, including:
cutting subsequent alternate sheets of second material in correspondence with sheets of first material to permit efficient joining of those alternate sheets of first and second pieces of sheet material.

11. The method as recited in claim 9, including:
moving said cutter head by a gearing arrangement driven by a computer controlled motor on said traveling beam; and
cutting said first and second pieces of material alternatively, in a corresponding shape but dissimilar size from one another.

12. The method as recited in claim 9, including:
moving said cutter head by a drive belt arrangement driven by a computer controlled motor on said traveling beam.

13. The method as recited in claim 9, including:
moving said traveling beam on said platform by a gearing arrangement driven by a computer controlled motor on said traveling beam.

14. An apparatus for the proper shaped cutting of alternate components of sheet material fittings for subsequent joining as ductwork, comprising:
a main support platform defined by a rectangular peripheral frame of side beams and end beams;
a cutter head movably arranged over said platform to cut sheet material on said platform;
a first shuttle table for receipt of a piece of first sheet material supported on said platform;
a second shuttle table for receipt of a piece of a second sheet material supported on said platform; and
a roller arrangement on said platform to permit one of said shuttle tables to be moved onto said platform as the other of said tables is moved from said platform, to permit alternate pieces of sheet material fittings to be cut by said cutter head over said platform in corresponding sequence with one another, wherein said first table and said second table are joined by a common elongated bar arranged therebetween, said cutter head being movably supported on a traveling beam by a controlled drive motor to permit movement of said cutter head on said traveling beam.
